(19) United States
(12) Patent Application Publication
(10) Pub. No.: US 2025/0297844 A1
(43) Pub. Date: Sep. 25, 2025

(54) DEFLECTION GAUGE

(71) Applicant: OATEY CO., Cleveland, OH (US)

(72) Inventors: Brady BURBY, Bloomington, MN (US); Asim SYED, Chanhassen, MN (US)

(21) Appl. No.: 19/083,636

(22) Filed: Mar. 19, 2025

Related U.S. Application Data
(60) Provisional application No. 63/567,756, filed on Mar. 20, 2024.

(51) Int. Cl. G01B 3/50; G01B 5/20

(52) U.S. Cl. CPC G01B 3/50; G01B 5/201

(57) ABSTRACT

Disclosed herein are pipe deflection gauges comprising a first guide disc having an outer circumferential edge that functions as the gauge surface, as distinguished from prior art devices, in which discrete rods or fins affixed to a central support define the gauge surface. The disclosed deflection gauges advantageously provide a cross-sectional profile having an altitude that is substantially the same as the maximum outer diameter, and therefore better align with user expectations for measurement of deflection, while being able to comply with regulatory standards by providing an accurate assessment of compliance of a particular pipe.

### CROSS-REFERENCE TO RELATED APPLICATIONS

This application claims the benefit of priority to U.S. Provisional Application No. 63/567,756, filed Mar. 20, 2024, the entire contents of which are incorporated herein by reference.

### TECHNICAL FIELD

The present disclosure pertains to devices and methods for testing of deflection inside of a pipe.

### BACKGROUND

Deflection gauges (often referred to as mandrels) are used to test piping, such as flexible sewer piping, for out-of-roundness or for deflection. For example, testing may be conducted per ASTM specifications D3034 and F679. This testing is intended to ensure that flexible pipe has been properly bedded and backfilled to give optimal performance. An ideal gauge should be able to account for all relevant features that are indicative of distortion of the tested pipe, including flat spots, high spots, and uneven deflection.

### SUMMARY

Disclosed herein are pipe deflection gauges comprising a long axis, a first gauge disc positioned along a disc axis that is perpendicular to the long axis, a second gauge disc, and, at least one guide rod extending along the long axis and engaging both the first gauge disc and second gauge disc in order to secure the position of the first gauge disc relative to the second gauge disc along the long axis, wherein the first gauge disc comprises an outer circumferential edge defining both an outer diameter and an altitude of the gauge.

Also provided herein are pipe deflection gauges comprising a first gauge disc having an outer diameter, the pipe deflection gauge defining an altitude that is equal to the outer diameter of the first gauge disc.

The present disclosure also includes systems comprising a pipe deflection gauge according to any described embodiment, a pull cable, and an attachment point between the pipe deflection gauge and the pull cable, such that the pipe deflection gauge can be drawn through the bore of a pipe by pulling the pull cable through the bore of the pipe.

Also disclosed herein are methods of conducting deflection testing with respect to a pipe having a first end, a second end, and bore extending between the first end and the second end, the bore defining an inner diameter of the pipe, the method comprising inserting a pipe deflection gauge according to any embodiment according to the present disclosure into the first end of the pipe, the pipe deflection gauge having an outer diameter that is sized in order to represent a percentage of the inner diameter of the pipe; and pulling the pipe deflection gauge through the bore of the pipe, wherein successful traversal by deflection gauge through the bore from the first end of the pipe to the second end of the pipe is indicative of a successful deflection test.

### BRIEF DESCRIPTION OF THE DRAWINGS

FIGS. 1A and 1B provide views of some embodiments of a deflection gauges.

FIGS. 2A and 2B provide views of some embodiments of a deflection gauge according to the present disclosure.

FIGS. 3A and 3B provide views of some further embodiments of a deflection gauge according to the present disclosure.

FIG. 4 depicts a further embodiment of a first gauge disc of an inventive deflection gauge.

FIG. 5 provides a perspective view of yet another embodiment of a deflection gauge according to the present disclosure.

### DETAILED DESCRIPTION OF ILLUSTRATIVE EMBODIMENTS

The presently disclosed inventive subject matter may be understood more readily by reference to the following detailed description taken in connection with the accompanying figures and examples, which form a part of this disclosure. It is to be understood that these inventions are not limited to the specific products, methods, conditions or parameters described and/or shown herein, and that the terminology used herein is for the purpose of describing particular embodiments by way of example only and is not intended to be limiting of the claimed inventions.

The entire disclosures of each patent, patent application, and publication cited or described in this document are hereby incorporated herein by reference.

As employed above and throughout the disclosure, the following terms and abbreviations, unless otherwise indicated, shall be understood to have the following meanings.

In the present disclosure the singular forms “a,” “an,” and “the” include the plural reference, and reference to a particular numerical value includes at least that particular value, unless the context clearly indicates otherwise. Thus, for example, a reference to “an anchor” is a reference to one or more of such anchors and equivalents thereof known to those skilled in the art, and so forth. Furthermore, when indicating that a certain element “may be” X, Y, or Z, it is not intended by such usage to exclude in all instances other choices for the element.

When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive; as another example, the phrase “about 8%” preferably refers to a value of 7.2% to 8.8%, inclusive. Where present, all ranges are inclusive and combinable. For example, when a range of “1 to 5” is recited, the recited range should be construed as optionally including ranges “1 to 4”, “1 to 3”, “1-2”, “1-2 & 4-5”, “1-3 & 5”, and the like. In addition, when a list of alternatives is positively provided, such a listing can also include embodiments where any of the alternatives may be excluded. For example, when a range of “1 to 5” is described, such a description can support situations whereby any of 1, 2, 3, 4, or 5 are excluded; thus, a recitation of “1 to 5” may support “1 and 3-5, but not 2”, or simply “wherein 2 is not included.” The phrase “at least about x” is intended to embrace both “about x” and “at least x”.

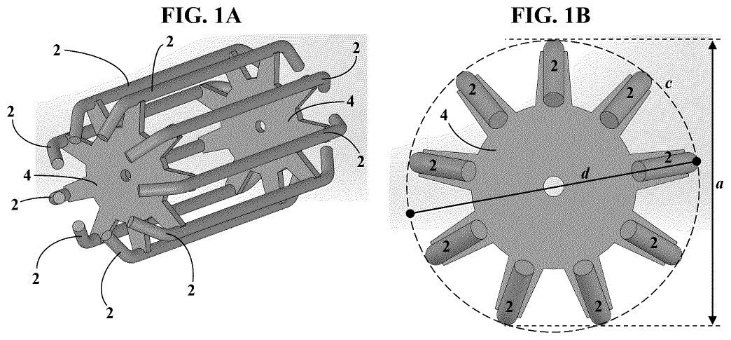

Appendix X1 of ASTM D3034 states “For the purpose of monitoring the quality of installation, a specifier may apply a deflection limit that he deems appropriate to the base inside diameter to arrive at a mandrel dimension for a go/no-go gage.” The standard goes on to describe how the sizing of the deflection gauge should be for manufacturing. However, end users may not appreciate what the standard is conveying, and the implications of the standard for the characteristics of the gauge. This is because in currently available deflection gauges, the altitude (i.e., the shortest distance, when the gauge is resting on a substantially planar surface, between the substantially planar surface and an uppermost point on the outer surface of the gauge) is smaller than the diameter (the maximum distance across the cross-section of the gauge). FIG. 1A provides a perspective view of some embodiments of a deflection gauge, and FIG. 1B provides a frontal view of the deflection gauge, in which line a represents the altitude and line d represents the diameter, and a<d. Thus, while an end user may believe that such a deflection gauge will not pass through a deflected pipe having an inner diameter that is less than the outer diameter of the gauge, in reality, the gauge will not pass through a deflected pipe only if the deflected pipe has an inner diameter that is less than the altitude of the gauge.

For example, a deflection gauge may be said to represent a 5% deflection gauge for SDR-35 Pipe per ASTM D3034, with markings indicating it is for use in 6″ SDR-35 pipe and referencing ASTM D3034. An end user may think that this gauge will not pass through a 6″ SSDR-35 pipe if the pipe is deflected by greater than 5%. This would be true if the outer diameter of the deflection gauge also represented the altitude of the gauge, but—as shown in FIG. 1B—some deflection gauges actually have altitude that is less than 95% of the inner diameter of a 6″ SDR-35 pipe. As a result, to the extent that a standard requires that an installed pipe cannot be deflected by greater than a particular percentage (e.g., by no more than 5% from the nominal inner diameter), such gauges cannot properly be relied on to demonstrate compliance of a particular pipe with that standard.

The presently disclosed deflection gauges advantageously remedy this shortcoming of previous systems by providing a cross-sectional (frontal) profile having an altitude that is substantially the same as the maximum outer diameter. The instant gauges therefore better align with user expectations for measurement of deflection, while being able to comply with regulatory standards by providing an accurate assessment of compliance of a particular pipe. As used herein when referring to the relationship between the altitude and outer diameter of the presently disclosed deflection gauges, “substantially the same” can mean that the distance defining the altitude is equal to the distance defining the outer diameter, but also allows for minor differences due to manufacturing limitations, manufacturing tolerances, or both. For example, such minor differences can result in a +/−0.02″ difference between the distance defining the altitude and the distance defining the outer diameter.

In some typical gauges, such as the gauge depicted in FIGS. 1A and 1B, the outer surfaces of rods 2 aligned with the long axis define the altitude a and outer diameter d (FIG. 1B). End plates 4 are included in order to support the rods 2.

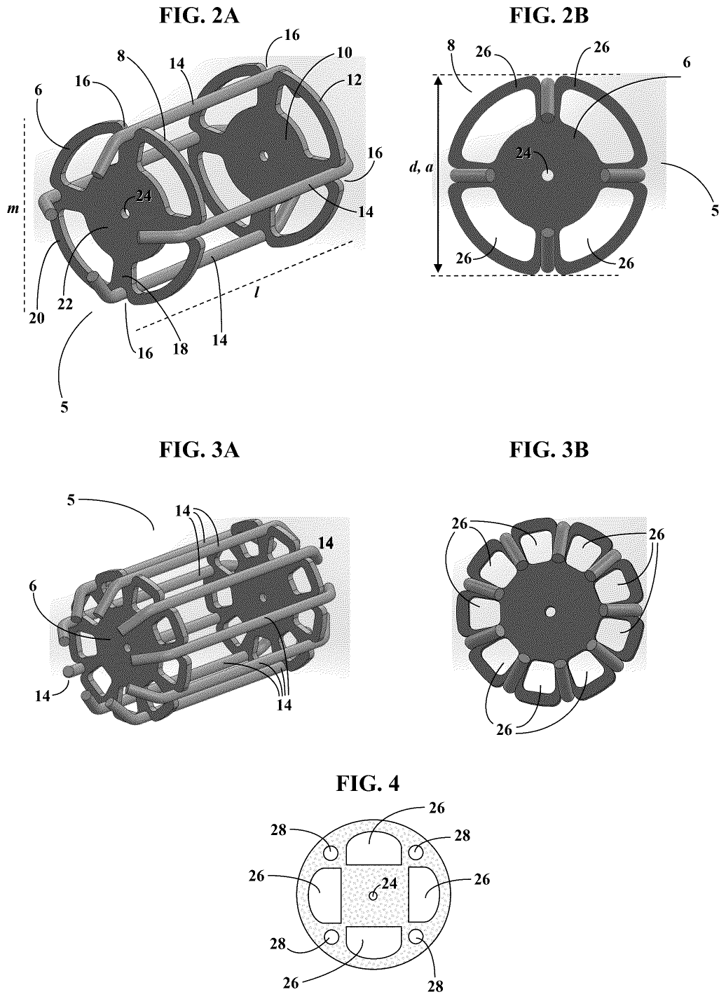

In the presently disclosed gauges, as illustrated in FIGS. 2A-3B and 3A-3B, a first gauge disc 6 comprises an outer circumferential edge 8 defining an outer diameter d of the gauge 5 that is the same as the altitude of the gauge 5. One or more guide rods 14, which are radially inset relative to the outer circumferential edge 8 of first gauge disc 6, do not necessarily define the outer diameter of the present gauges. Thus, the outer diameter of the present gauges is defined by the dimensions of the first gauge disc 6, rather than by any dimension resulting from the frontal profile produced by the guide rod(s). As a result of this configuration, the first gauge disc (more precisely, the outer circumferential edge thereof) functions as the gauge surface, as distinguished from prior art devices such as that illustrated in FIGS. 1A and 1B, in which end plates 4 support the rod(s) 2, and the rod(s) 2 define the gauge surface. In other embodiments, the guide rod or rods are not necessarily radially inset relative to the outer circumferential edge, and, together with the outer circumferential edge of the first gauge disc, can collectively define the outer diameter (which is still unlike the gauges depicted in FIGS. 1A and 1B, in which the outer surfaces of rods 2 aligned with the long axis define the altitude a and outer diameter d).

Accordingly, disclosed herein are pipe deflection gauges comprising a long axis, a first gauge disc positioned along a disc axis that is perpendicular to the long axis, a second gauge disc, and, at least one guide rod extending along the long axis and engaging both the first gauge disc and second gauge disc in order to secure the position of the first gauge disc relative to the second gauge disc along the long axis, wherein the first gauge disc comprises an outer circumferential edge defining both an outer diameter and an altitude of the gauge.

In the embodiment depicted in FIG. 2A, first gauge disc 6 is positioned along disc axis m, which is perpendicular to long axis 1. Being that outer circumferential edge 8 of first gauge disc 6 represents both the shortest distance and the longest distance between two points on opposite sides of the outer surface of the gauge that both contact the nominal inner surface of a pipe, outer circumferential edge 8 defines both the altitude and the outer diameter of gauge 5.

In the embodiment of FIG. 2A, the outer diameter of second gauge disc 10 (as defined by outer circumferential edge 12) is the same as the outer diameter of first gauge disc 6. In other embodiments, the outer diameter of the second gauge disc is less than the outer diameter of the first gauge disc, such that only the outer circumferential edge of the first gauge disc defines the outer diameter of the gauge for purposes of deflection testing. In still other embodiments, the outer diameter of the second gauge disc is greater than the outer diameter of the first gauge disc, such that only the outer circumferential edge of the second gauge disc defines the outer diameter of the gauge for purposes of deflection testing. When the outer diameter of one of the gauge discs is less than the outer diameter of the other of the gauge discs, the gauge disc having the smaller diameter need not have the same general shape profile as the other gauge disc, and may well have a different shape profile. For example, whereas the first gauge disc is the larger of the two and is circular (in accordance with the nominal/undeflected shape of the bore of a pipe), the second gauge disc may be triangular, polygonal (e.g., square-shaped, rectangular, pentagonal, hexagonal, heptagonal, octagonal, nonagonal, decagonal, etc.), oval, star-shaped, or irregularly shaped. In fact, smaller of the two gauge discs need not have a disc-shaped three-dimensional aspect—instead, the three-dimensional aspect of the component may be that of a pyramid, cube or other polyhedron, sphere, ovoid, or other three-dimensional shape. In such embodiments, the phrase “gauge disc” can refer to non-disc-shaped configurations. Also, when the outer diameter of one of the two gauge discs is less than the outer diameter of the other of the gauge discs, the smaller gauge disc need not be oriented along disc axis m, and may be oriented at a nonzero angle away from disc axis m.

The distance between the first gauge disc and the second gauge disc is preferably at least the same as the diameter of the first gauge disc, when the first gauge disc has a diameter that is greater than or the same as the diameter of the second gauge disc. In embodiments in which the outer diameter of the second gauge disc is greater than that of the first gauge disc, then the distance between the first and second gauge discs is preferably at least the distance defining the outer diameter of the second gauge disc. Generally speaking, if the distance between the first gauge disc and the second gauge disc (e.g., the closest surface of the second gauge disc) is smaller than the diameter of the larger of the gauge discs, then the pipe deflection gauge will be able to rotate or flip inside the pipe, which will invalidate the pipe roundness measurements. When the first gauge disc has a diameter that is greater than or the same as the diameter of the second gauge disc, the preferred maximum distance between the first gauge disc and the second gauge disc is about two times the outer diameter of the first gauge disc. With respect to such embodiments, if the maximum distance between the first gauge disc and the second gauge disc is greater than about two times the outer diameter of the first gauge disc, the pipe deflection gauge may not be able to pass through bends typically found along a length of pipe (e.g., 30 degree joints, 45 degree joints, 90 degree joints, etc.), thereby limiting the applications in which the deflection gauge may be utilized. In embodiments in which the outer diameter of the second gauge disc is greater than that of the first gauge disc, then the maximum distance between the first and second gauge discs is preferably two times the diameter of the second gauge disc. With respect to such embodiments, if the maximum distance between the first gauge disc and the second gauge disc is greater than about two times the outer diameter of the second gauge disc, the pipe deflection gauge may not be able to pass through bends typically found along a length of pipe (e.g., 30 degree joints, 45 degree joints, 90 degree joints, etc.), thereby limiting the applications in which the deflection gauge may be utilized.

In FIG. 2A, respective guide rods 14 extend along long axis l and engage both first gauge disc 6 and second gauge disc 10 at corresponding notches 16 within the respective discs. In this embodiment, the depth of the notches are greater than the outer diameters of the guide rods 14, so that the guide rods are fully sunken within the notches 16 (FIG. 2B) and thereby do not define the outer diameter of the gauge 5. Therefore, one purpose of the guide rods is to secure the position of the first gauge disc relative to the second gauge disc along the long axis of the gauge. ASTM standards may require a certain distance between the first gauge disc and the second gauge disc, and the guide rods may be sized in terms of their length accordingly. The guide rods also provide angular stability for the gauge in order to avoid tilting of the first gauge disc away from the disc axis m. The respective guide rods may have an overall length that is the same as or is greater than a desired distance between the first guide disc and the second guide disc. In the embodiment of FIG. 2A, guide rods 14 extend past the point of engagement at notches 16 with first gauge disc 6, and also extend past the point of engagement at notches 16 with second gauge disc 10. In this way, guide rods 14 define a proximal end and a distal end of the gauge 5. In other embodiments, the guide rods do not extend past the point of engagement with first guide disc, past the point of engagement with the second guide disc, or both. In other words, in such embodiments, the guide rods may terminate at the point of engagement with the first guide disc, may terminate at the point of engagement with the second guide disc, or both.

In FIG. 2A, guide rods 14 include a crimp or bend just past the point of engagement at notches 16 with first gauge disc 6, such that the ends of guide rods 14 are angularly oriented towards the radial center of gauge 5. In other embodiments, the guide rods 14 do not include a bend or crimp.

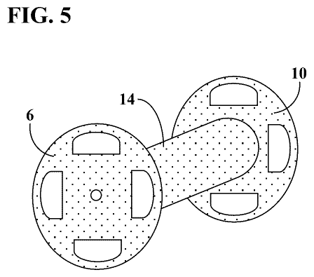

The total number of guide rods that are used for the pipe deflection gauge can be selected as needed. The embodiment of FIG. 5 includes a single guide rod 14 that extends between a first gauge disc 6 and a second gauge disc 10. In other embodiments, at least two guide rods may be preferred in order to confer stability of the gauge along the long axis thereof and along the axis defined by the linear cavity within a pipe. The total number of guide rods may be, for example, 1, 2, 3, 4, 5, 6, 7, 8, 9, 10, or more than 10. FIG. 3A provides a perspective view, and FIG. 3B provides a frontal view, of a further embodiment of a gauge 5 according to the present disclosure that includes a first gauge disc 6 and nine guide rods 14. Although, strictly speaking, the applicable ASTM standard requires nine or more legs for a deflection gauge, this standard is not relevant to the number of guide rods in the presently disclosed gauges, because, as described supra, the present guide rods do not represent the guide surface of the present devices. Rather, the first gauge disc represents the guide surface, and the outer circumferential edge of the first gauge disc effectively represents an infinite number of “legs”. Thus, the number of guide rods in the present gauges may be selected as needed with respect to considerations other than the ASTM standard, e.g., may be selected in order to confer stability. For example, in some instances, a guide having four or more rods is desirable as this number of rods can provide increased rigidity between the discs, thereby improving durability of the gauge. It may be that without such stability, in some embodiments, a force applied to the disc (e.g., shear force) as it passes through the pipe may be great enough to at least partially sever or loosen the end discs from the rod, thereby impeding or destroying the ability of the deflection gauge to function as intended. The ASTM standard requiring nine or more legs is intended to maximize contact of the gauge with the inner surface of the pipe to be tested, but can also be beneficial in the context of the presently disclosed gauges for ensuring stability against otherwise distorting forces or simply for ensuring compliance with the ASTM standard, even if not strictly speaking required for the aforementioned reasons.

The cross-sectional profile of the rods shown in FIG. 2A are circular. However, guide rods according to the present disclosure need not have a circular profile, and can have any desired profile, including fin-shaped, ribbon-shaped, ovoid, tapered, screw-shaped (threaded or twisted), irregular, or any combination thereof (may have two or more different cross-sectional shapes).

The first gauge disc preferably includes one or more void spaces located radially interior relative to the outer circumferential edge. The void spaces allow fluid, soil, debris, or other material within a pipe being tested for deflection to bypass the gauge during traversal of the gauge through the pipe, whereas if the void spaces were not present, the material could otherwise block passage of the gauge. The shapes and sizes of the respective void spaces, arrangement of the void spaces in the disc, and total number of void spaces can be selected as required in order to optimize traversal of the gauge through the bore of a pipe while ensuring the structural integrity of the disc. As can be seen from FIGS. 2B and 3B, the number and shape of void spaces 26 may also be at least partially dictated by the number of guide rods 14, but need not be. In some embodiments, the presence of the void spaces will result in a configuration of the first gauge disc whereby the disc includes an outer ring portion defining the outer circumferential edge, a central support portion, and struts that extend between the outer ring portion and the central support portion. In the embodiment of FIGS. 2A and 2B, there are four struts 18 connecting an outer ring portion 20 to a central support portion 22.

The first gauge disc can include an attachment point for attachment to a means for pulling the pipe deflection gauge, e.g., a cable as defined herein, through the bore of a pipe. The attachment point can include a void space, ring, eye screw, hook, eyelet, stud, or any other feature or mechanism for attachment to a pull cable. In the embodiment of FIGS. 2A and 2B, first gauge disc is machined with an attachment point 24 represented by a void space in central support portion 22. The interior face of an attachment point 24 comprising a void space can include threading in order to allow a ring, hook, or stud having a complementarily threaded stem to be removably attached to the gauge disc. Alternatively, the attachment point 24 comprising a void space can accommodate a ring, hook, or stud for permanent fixation to the gauge via the attachment point. In a further embodiment, the attachment point comprises one or more void spaces directly through which a cable can be threaded and thereby affixed to the gauge. For example, the attachment point can comprise two adjacent circular void spaces through which a cable can be looped and then tied or crimped in order to affix the cable to the gauge. It should be noted that in embodiments in which the first gauge disc has a smaller diameter than that of the second gauge disc (and thereby that only the outer circumferential edge of the second gauge disc defines the outer diameter of the gauge for purposes of deflection testing), the first gauge disc can still include an attachment point having any configuration described herein for attachment to a means for pulling the pipe deflection gauge with the first gauge disc representing the leading end of the gauge.

As noted, the guide rods in the embodiments shown in FIGS. 2A-3B engage the first gauge disc via notches 16. In other embodiments, the rods engage the first gauge disc differently, or using a combination of notches and a different engagement configuration. For example, the rods may engage the first gauge disc via holes that are located in the disc radially inward from the outer circumferential edge. FIG. 4 provides a frontal view of an exemplary first gauge disc 6 with attachment point 24 representing a void space, void spaces 26, and rod holes 28. As disclosed supra, the total number of guide rods may be, for example, 1, 2, 3, 4, 5, 6, 7, 8, 9, 10, or more than 10, so when holes are used for engaging the guide rods, the number of holes may correspond to the number of guide rods to be used. In some embodiments, fewer guide rods than the number of holes may be used. For example, a first guide disc may be machined with 10 holes for optional engagement with guide rods, but the gauge may be manufactured with fewer than 10 guide rods. In other embodiments, the guide rods engage the first gauge disc via a combination of holes and another engagement configuration, such as notches. In other embodiments, the rods may be welded, glued, or otherwise affixed directly to a surface of the gauge disc, such as the surface of a gauge disc facing the other gauge disc. For example, the rods may be affixed to a surface of the first gauge disc that faces the second gauge disc and the trailing end of the gauge.

In some embodiments, there are one or more further gauge discs in addition to the first gauge disc and the second gauge disc. In embodiments in which the displacement gauge only includes a first gauge disc, the one or more further gauge discs may comprise a second gauge disc, a third gauge disc, etc. The further gauge discs may have a configuration according to any of the presently disclosed embodiments of a first gauge disc, or according to any of the presently disclosed embodiments of a second gauge disc. For example, the present deflection gauges may include 1, 2, 3, 4, or 5 further gauge discs. The gauge rods may physically engage the one or more further gauge discs in the same manner as they engage the first gauge disc or the second gauge disc, e.g., via notches, holes, welds, or a different engagement configuration.

The gauges according to the present disclosure may be sized as needed in order to provide a desired outer diameter relative to the nominal diameter of the bore of a pipe (inner diameter of a pipe) to be tested. The outer diameter may be selected to represent a set percentage of the nominal inner diameter of a pipe to be subjected to deflection testing. For example, the gauge may be sized in order to prevent passage through a particular pipe if the pipe is deflected by greater than a particular percentage, such as by 2%, 3%, 4%, 5%, 6%, 7%, or 8%.

The respective components of the pipe deflection gauges according to the embodiments disclosed herein may be constructed using any material rendering the components suitable for the intended purpose of withstanding traversal through the bore of a pipe that may include deflected sections. Exemplary materials for the first and second guide discs and the rods include, for example, aluminum, steel, nickel, other metals or alloys, or thermoplastic polymer (for example, polyvinyl chloride (PVC) or acrylonitrile butadiene styrene (ABS)). When the attachment point includes a ring, eye screw, hook, eyelet, stud, or other feature for attachment to a cable, the attachment point may comprise a suitable material, including any of those listed above with respect to the discs and rods. Preferred materials for an attachment point, such as when the attachment point includes a ring, eye screw, or hook, are aluminum and steel.

Also provided herein are pipe deflection gauges comprising a first gauge disc having an outer diameter, wherein the gauge defines an altitude that is equal to the outer diameter of the first gauge disc. As described supra, typical pipe deflection gauges, such as the one depicted in FIGS. 1A and 1B, have an altitude that is less than the outer diameter of the gauge. In gauges according to the present embodiment, the first gauge disc may have any of the characteristics described above in connection with the other disclosed embodiments. The present embodiment may further include two or more guide rods, a second gauge disc, one or more further gauge discs, or any combination thereof, wherein the respective characteristics of these components may be the same as in any of the other embodiments disclosed supra.

The present disclosure also provides pipe deflection gauges comprising a first gauge disc having an outer circumferential edge, wherein the outer circumferential edge represents a guide surface of the pipe deflection gauge. As described supra, in typical pipe deflection gauges, such as the one depicted in FIGS. 1A and 1B, discrete rods or fins affixed to a central support define the gauge surface. In gauges according to the present embodiment, the first gauge disc may have any of the characteristics described above in connection with the other disclosed embodiments. The present embodiment may further include two or more guide rods, a second gauge disc, one or more further gauge discs, or any combination thereof, wherein the respective characteristics of these components may be the same as in any of the other embodiments disclosed supra.

The present disclosure also provides systems comprising a pipe deflection gauge according to any of the presently disclosed embodiments and a pull cable. The pull cable may be any rope-like element that can be affixed to an attachment point of the deflection gauge, so that the gauge can be drawn through a bore of a pipe by pulling the pull cable through the pipe. Pull cables may be true cables (i.e., woven wire) or may be composed of non-metallic natural or artificial material, such as polymer or fiber. Any suitable cable, cord, string, twine, line, or rope may be used for the pull cable, provided it can be securely affixed to the deflection gauge, and withstand the forces involved in testing deflection (including those imposed when a deflection or other obstruction is encountered) without breaking.

Also provided herein are methods of conducting deflection testing with respect to a pipe having a first end, a second end, and bore extending between the first end and the second end, the bore defining an inner diameter of the pipe, the method comprising inserting the pipe deflection gauge according to any one of the embodiments described in the present disclosure into the first end of the pipe, the pipe deflection gauge having an outer diameter that is sized in order to represent a percentage of a nominal inner diameter of the pipe, and pulling the pipe deflection gauge through the bore of the pipe, wherein successful traversal by deflection gauge through the bore from the first end of the pipe to the second end of the pipe is indicative of a successful deflection test.

The pipe that is subjected to the deflecting testing is any type of piping that may be vulnerable to deflection or distortion that can result in out-of-roundness, such as flexible sewer piping. The first end of the pipe simply represents an opening in the pipe through which the deflection gauge can be inserted into the bore at the beginning of the deflection testing. The second end of the pipe represents any point along the pipe that is longitudinally displaced from the first end. The second end is not necessarily the point at which the pipe ends—deflection testing typically does not require measurement of the entire length of the tested pipe. For example, being that certain deflection testing requirements may specify that at least 10% of a pipe must be tested, the second end can represent a point along the piping that is longitudinally displaced from the first end at a distance of at least 10% of the total length of the piping being subjected to deflection testing. In some instances, the second end of the pipe represents a point along the piping that is longitudinally displaced from the first end at a distance of at least 5, 6, 7, 8, 9, 10, 11, 12, 13, 14, 15, 16, 17, 18, 19, 20, 21, 22, 23, 24, 25, 26, 27, 28, 29, or 30% of the total length of the piping being subjected to deflection testing, or that is about 5, 10, 15, 20, 25, 30, 35, 40, 45, 50, 55, 60, 65, 70, 75, 80, 85, 90, 95, or 99% of the total length of the piping being subjected to deflection testing.

Insertion of the pipe deflection gauge into the first end of the pipe may be conducted according to techniques that are well known among those skilled in the art.

As described above, the pipe deflection gauge that is used in accordance with the present methods is sized in order to represent a percentage of a nominal inner diameter of the pipe, such that deflection of the pipe that results in a reduction of the actual inner diameter of at least one section the pipe may result in an unsuccessful deflection test. For example, the gauge may be sized in order to prevent passage through a particular pipe if any tested section of the pipe is deflected by greater than a particular percentage, such as by 2%, 3%, 4%, 5%, 6%, 7%, or 8%. Stated differently, the outer diameter of the gauge may be sized such that if the actual inner diameter of a section of the pipe is less than the nominal inner diameter by about 2%, 3%, 4%, 5%, 6%, 7%, or 8%, the gauge will not pass through that section of the pipe, thereby indicating failure of that section of the pipe with respect to the deflection testing. On the other hand, successful traversal by the deflection gauge through the tested section of the bore of the pipe is indicative of a successful deflection test, meaning that the tested section of the bore has not deflected by more than a prescribed percentage of the nominal inner diameter of the bore.

### EXAMPLES

The present invention is further defined in the following Example. It should be understood that the example, while indicating preferred embodiments of the invention, is given by way of illustration only, and should not be construed as limiting the appended claims. From the above discussion and the example, one skilled in the art can ascertain the essential characteristics of this invention, and without departing from the spirit and scope thereof, can make various changes and modifications of the invention to adapt it to various usages and conditions.

### Example 1—Use of Deflection Gauge for Testing of Pipe

A deflection gauge is provided with markings indicating that it represents a 5% deflection gauge for use in 6″ SDR-35 pipe and referencing ASTM D3034. The deflection gauge includes a first gauge disc having a configuration as shown in FIGS. 2A and 2B. In view of the intended use of the gauge, the outer diameter of the first gauge disc is 5.7″. The deflection gauge is also provided with a second gauge disc having a configuration that is identical to that of the first gauge disc, and four guide rods positioned at evenly spaced locations about the circumference of the first and second gauge discs. The first gauge disc, second gauge disc, and guide rods comprise stainless steel. The first gauge disc also includes an attachment point comprising a stainless steel eye screw.

The deflection gauge is placed through an opening in the SDR-35 pipe and into the bore. The piping has a total length of 100 ft. The gauge is pulled through the bore of the piping using nylon twine that is affixed to the attachment point of the deflection gauge until it exits the piping at an end opposite the initial opening. The successful passage of the gauge through the piping indicates that the tested length of pipe does not include any deflection greater than 5% of the nominal inner diameter of the pipe (no deflection exceeding 0.3″).

What is claimed:

1. A pipe deflection gauge comprising:
a long axis;
a first gauge disc positioned along a disc axis that is perpendicular to the long axis;
a second gauge disc; and,
at least one guide rod extending along the long axis and engaging both the first gauge disc and second gauge disc in order to secure the position of the first gauge disc relative to the second gauge disc along the long axis,
wherein the first gauge disc comprises an outer circumferential edge defining both an outer diameter and an altitude of the gauge.

2. The pipe deflection gauge according to claim 1, wherein both the first gauge disc and the second gauge disc define the outer diameter of the gauge.

3. The pipe deflection gauge according to claim 1, wherein the second gauge disc is positioned along the disc axis.

4. The pipe deflection gauge according to claim 1, wherein at least one guide rod defines a proximal end of the gauge and a distal end of the gauge.

5. The pipe deflection gauge according to claim 1, wherein the outer circumferential edge of the first gauge disc includes a notch for engaging at least one guide rod.

6. The pipe deflection gauge according to claim 1, comprising four or more guide rods.

7. The pipe deflection gauge according to claim 1, comprising nine or more guide rods.

8. The pipe deflection gauge according to claim 1, wherein the at least one guide rod comprises a first opposing guide rod that is positioned at a first location along the outer circumferential edge of the first gauge disc, and a second opposing guide rod that is positioned at a second location substantially opposite the first location on the outer circumferential edge, and wherein the outer diameter of the gauge is greater than the distance between the first location and the second location.

9. The pipe deflection gauge according to claim 1, wherein the first gauge disc includes an outer ring portion defining the outer circumferential edge, a central support portion, and struts that extend between the outer ring portion and the central support portion.

10. The pipe deflection gauge according to claim 1, wherein the first gauge disc comprises an attachment point for attachment to a cable for pulling the pipe deflection gauge through a bore of a pipe.

11. The pipe deflection gauge according to claim 10, wherein the attachment point comprises a ring, hook, stud, or void space.

12. The pipe deflection gauge according to claim 1, wherein the outer diameter of the first gauge disc is sized in order to represent a set percentage of a nominal inner diameter of a pipe.

13. A pipe deflection gauge comprising a first gauge disc having an outer diameter, the pipe deflection gauge defining an altitude that is equal to the outer diameter of the first gauge disc.

14. A pipe deflection gauge comprising:
a first gauge disc having an outer circumferential edge;
wherein the outer circumferential edge represents a guide surface of the pipe deflection gauge, wherein an altitude of the pipe deflection gauge is equal to a distance between two opposite points disposed on the outer circumferential edge, wherein the pipe deflection gauge is configured to pass through a bore of a pipe to determine if a section of the pipe is deflected by more than a predefined percentage of a nominal inner diameter of the section of the pipe.

15. A system comprising the pipe deflection gauge according to claim 10 and a pull cable, wherein the pull cable is affixed to the attachment point of the deflection gauge, such that the pipe deflection gauge can be drawn through a bore of a pipe by pulling the pull cable through the bore.

16. A method of conducting deflection testing with respect to a pipe having a first end, a second end, and bore extending between the first end and the second end, the bore defining an inner diameter of the pipe, the method comprising:
inserting the pipe deflection gauge according to claim 1 into the first end of the pipe, the pipe deflection gauge having an outer diameter that is sized in order to represent a percentage of the inner diameter of the pipe; and
pulling the pipe deflection gauge through the bore of the pipe,
wherein successful traversal by deflection gauge through the bore from the first end of the pipe to the second end of the pipe is indicative of a successful deflection test.

17. A method of conducting deflection testing with respect to a pipe having a first end, a second end, and bore extending between the first end and the second end, the bore defining an inner diameter of the pipe, the method comprising:
inserting the pipe deflection gauge according to claim 13 into the first end of the pipe, the pipe deflection gauge having an outer diameter that is sized in order to represent a percentage of the inner diameter of the pipe; and
pulling the pipe deflection gauge through the bore of the pipe,
wherein successful traversal by deflection gauge through the bore from the first end of the pipe to the second end of the pipe is indicative of a successful deflection test.

18. A method of conducting deflection testing with respect to a pipe having a first end, a second end, and bore extending between the first end and the second end, the bore defining an inner diameter of the pipe, the method comprising:
inserting the pipe deflection gauge according to claim 14 into the first end of the pipe, the pipe deflection gauge having an outer diameter that is sized in order to represent a percentage of the inner diameter of the pipe; and
pulling the pipe deflection gauge through the bore of the pipe,
wherein successful traversal by deflection gauge through the bore from the first end of the pipe to the second end of the pipe is indicative of a successful deflection test.
